(19) United States
(12) Patent Application Publication
(10) Pub. No.: US 2022/0198814 A1
(43) Pub. Date: Jun. 23, 2022

(54) IMAGE DEWARPING WITH CURVED DOCUMENT BOUNDARIES

(71) Applicant: Hewlett-Packard Development Company, L.P., Spring, TX (US)

(72) Inventors: Sebastien Tandel, Porto Alegre (BR); Ricardo Ribani, Alphaville (BR); Ricardo Farias Bidart Piccoli, Porto Alegre (BR); Tiago de Padua, Porto Alegre (BR)

(73) Assignee: Hewlett-Packard Development Company, L.P., Spring, TX (US)

(21) Appl. No.: 17/603,139

(22) PCT Filed: Aug. 14, 2019
(86) PCT No.: PCT/US2019/046541

§ 371 Date: Oct. 12, 2021

(51) Int. Cl. G06V 30/146; G06V 30/16

(52) U.S. Cl. CPC G06V 30/1463; G06V 30/1607; G06V 30/1478

(57) ABSTRACT

An example non-transitory computer-readable medium includes instructions executable by a processor to detect boundaries of a representation of a document page in a captured image, model the boundaries of the representation of the document page as nonlinear curves, use the nonlinear curves to transform pixels of the representation of the document page into pixels of a dewarped representation of the document page, and output a dewarped image based on the dewarped representation of the document page.

### BACKGROUND

Computing devices, such as smartphones, often include cameras to capture various types of images. Images may be of different kinds of subjects, such as people, places, items of interest, and the like. Further, it has become increasingly common for such cameras to be used to capture images of documents.

### BRIEF DESCRIPTION OF THE DRAWINGS

FIG. 1 is a block diagram of an example device to use nonlinear curves to represent document boundaries to output a dewarped version of a captured image.

FIGS. 2A to 2H are screenshots of an example sequence from example captured image to example enhanced dewarped image using nonlinear curves to represent document boundaries.

FIG. 3 is a screenshot of an example result of line segment detection in an example process to use nonlinear curves to represent document boundaries.

FIG. 4 is a diagram of an example analysis of line segments to determine line segment groups.

FIG. 5A is a diagram of example line segment groups categorized into upper, lower, left, and right categories.

FIG. 5B is a diagram of example selected line segment groups from FIG. 5A as representative of document boundaries.

FIG. 5C is a diagram of example nonlinear curves that represent the selected line segment groups of FIG. 5B.

FIG. 6 is a diagram of a transform of a captured image to a dewarped image using nonlinear curves that represent document boundaries.

FIG. 7 is a flowchart of an example method of outputting a dewarped image of a document based on a captured image that is transformed using nonlinear curves that represent the boundaries of the document in the captured image.

FIG. 8 is a flowchart of an example method of performing an interpolation on a captured image of a document using nonlinear curves that represent the boundaries of a document in the captured image.

FIG. 9 is a block diagram of another example device to use nonlinear curves to represent document boundaries to output a dewarped version of a captured image,

### DETAILED DESCRIPTION

Images of documents may be captured with a camera, such as a smartphone camera. A user may intend to “scan” a document by taking a digital photograph of the document. However, the resulting photograph is often warped due to the angle of the camera, the optics of the camera, or imprecise placement of the document. In addition, when photographing a page of a book, due to the binding of the book, the page may tend to curve and may be difficult for the user to manually flatten.

A digital photograph of a document page may be dewarped by a process that models document boundaries as curves, such as polynomial curves. Image analysis may be performed on a digital photograph of a document page or other item having straight boundaries to obtain curves that define the appearance of the boundaries in the photograph. For example, a rectangular document page may be represented by four boundary curves. A transformation may then be computed using the curves. The transformation may be used to transform pixel coordinates in the image to pixel coordinates in a dewarped image that approximates a scan obtained if a flatbed scanner or similar device were to be used. Further, an off-the-shelf mobile computing device, such as a smartphone, may be used, rather than using specialized scanning equipment. A processing-intensive analysis of text direction or text flow to model, for example, a warped document page as a mesh or grid is not required. Document content may be ignored. As such, both text and image heavy documents may be accurately scanned by a user with his/her smartphone or similar device.

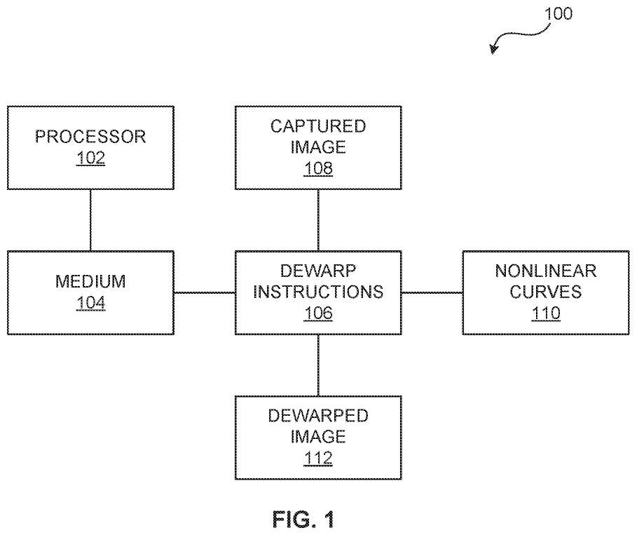

FIG. 1 shows an example device 100 that uses nonlinear curves to output a dewarped version of a captured image. The device 100 includes a processor 102 and a non-transitory computer-readable medium 104. The device 100 may be a handheld computing device, such as a smartphone, tablet computer, smart watch, or the like.

The processor 102 may include a central processing unit (CPU), a microcontroller, a microprocessor, a processing core, a field-programmable gate array (FPGA), or a similar device capable of executing instructions. The processor 102 may be connected to the non-transitory machine-readable medium 104. The processor 102 and medium 104 may cooperate to execute instructions.

The non-transitory machine-readable medium 104 may include an electronic, magnetic, optical, or other physical storage device that encodes executable instructions. The medium 104 may include, for example, random access memory (RAM), read-only memory (ROM), electrically-erasable programmable read-only memory (EEPROM), flash memory, a storage drive, an optical disc, or similar.

Image dewarp instructions 106 may be stored in the non-transitory machine-readable medium 104 to be executed by the processor 102.

The dewarp instructions 106 detect boundaries of a representation of a document page in a captured image 108. Further, the dewarp instructions 106 model the boundaries of the representation of the document page as nonlinear curves 110. Then, the image dewarp instructions 106 use the nonlinear curves 110 to transform pixels of the representation of the document page into pixels of a dewarped representation of the document page. Finally, the instructions 106 output a dewarped image 112 based on the dewarped representation of the document page.

The captured image 108, nonlinear curves 110, and dewarped image 112 may be stored in the medium 104 for purposes of the execution of the image dewarp instructions 106.

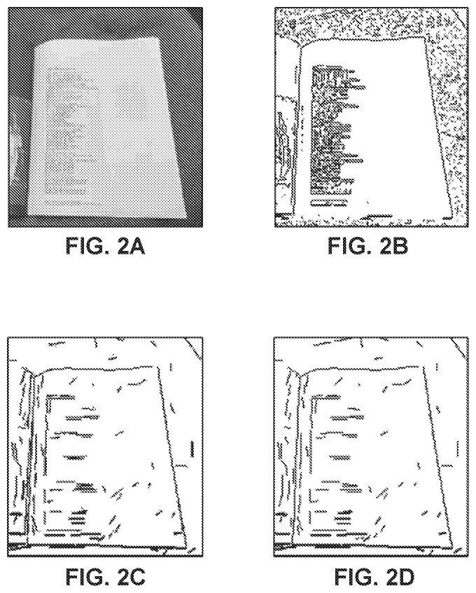

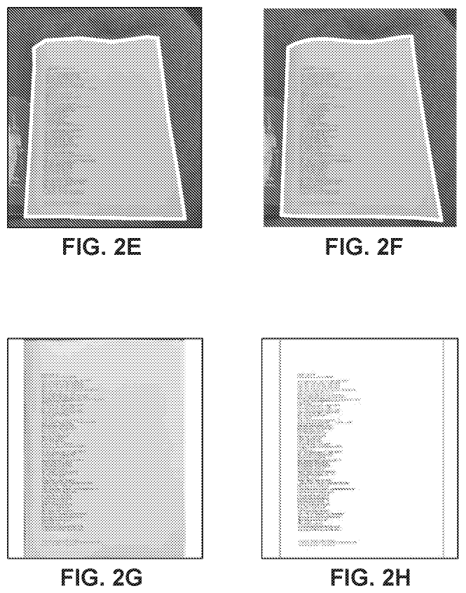

The captured image 108 may be captured by the device 100, such as by a digital camera at the device 100, or may be captured by another device. The captured image 108 includes a representation of a document page. This type of image may be captured by taking a digital photograph of a book page, a loose piece of paper, or similar document page. When the device 100 is held by the user to take such a photograph, the representation of the document page in the captured image 108 may not align with the borders of the image and may include warped or curved boundaries for the page, as shown in FIG. 2A.

Modelling the boundaries of the representation of the document page as nonlinear curves 110 may include performing edge detection (e.g., FIG. 2B), detecting line segments using edge information (e.g., FIG. 2C), associating or connecting line segments (e.g., FIG. 2D), discriminating the boundaries of the document from other lines/edges detected in the captured image (e.g., FIG. 2E), and then fitting the discriminated boundaries of the document to nonlinear curves 110 (e.g., FIG. 2F). The nonlinear curves 110 may be obtained without reference to content (e.g., text, images) of the document page in the captured image 108.

FIG. 2A shows an example captured image of a document page. Curved warping is apparent in the boundaries and content of the document page.

Edge detection, as shown in FIG. 2B, may use a Sobel operator or similar technique. Applying a blur or gaussian filter may assist in edge detection. Different intensities of blur or gaussian filter may be used, as a suitable degree of blur or gaussian filter may vary from captured image to captured image.

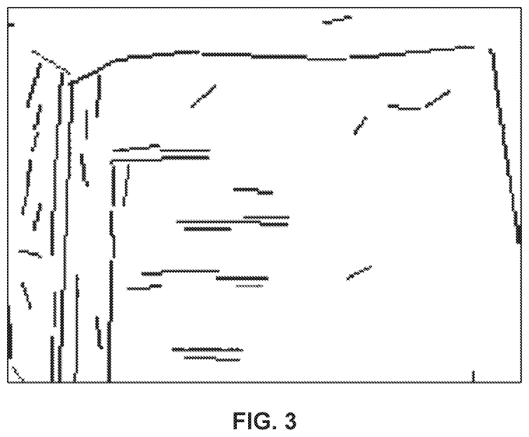

As shown in FIG. 2C, line segment detection may be performed on detected edges. Line segment detection may result in a collection of independent line segments. Various techniques may be used, such as a Hough Transform (en.wikipedia.org/wiki/Hough_transform), “Edge Linking” (en.wikipedia.org/wiki/Edge_detection#Thresholding_and_linking; users.cs.cfac.uk/Dave.Marshall/Vision_lecture/node31.html#SECTION0016100 0000000000000), or similar. FIG. 3 shows a close up of an example result of line segment detection. Line segments may be computationally modelled as endpoints.

With reference to FIG. 2D, associations of line segments within the collection of line segments may be made based on apparent end connections. Groups of line segments may be established. A group of line segments may represent a candidate for a physical boundary of the document.

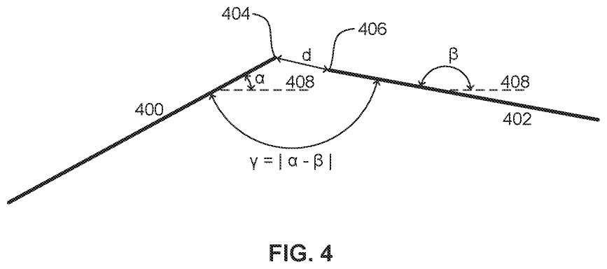

Line segments may be associated into groups with reference to endpoint proximity and angle between pairs of line segments. With reference to FIG. 4, two example line segments 400, 402 may be considered connected, and therefore associated, based on a distance, d, between the closest points 404, 406 of the segments 400, 402 and an angle, γ (gamma), between the segments 400, 402. The angle, γ (gamma), between the segments 400, 402 may be taken as the absolute value of the difference between the angles, α (alpha), and β (beta) of the respective line segments 400 and 402 to a datum angle, such as a horizontal line 408.

Iteration may be performed to compare pairs of line segments. For each pair of line segments, the pair may be determined to belong to the same group if a set of conditions is met. An example set of conditions is as follows:
a) the distance, d, between the two closest points of the segments is less than a predefined distance (e.g., 5 pixels); and
b) the angle, γ (gamma), between the two segments within a predefined angular range (e.g., +/−10 degrees).

The predefined distance and predefined angular range may be set, independently, to suitable values. The predefined distance may set to promote connections, so that line segments are readily grouped. The predefined angular range may be set based on expected curvature of document boundaries in captures images. For example, document pages laid flat may not require as large a predefined angular range as pages of an open book. In implementations useful for book page scanning, the predefined angular range may be set larger than in implementations that mainly consider loose-leaf pages.

After pairs of line segments have been considered for grouping, a collection of line segment groups is obtained. Each line segment group defines a polyline that potentially represents an outer boundary of the document page. It should be understood that the lines segments of a group need not have ends connected (i.e., located at the same coordinates) to be considered members of the group. It is sufficient for endpoints to be proximate and for mutual angle, γ (gamma), to be within an acceptable range.

Once line segments have been grouped, the line segment groups may be considered as candidates for boundaries of the document page. Discriminating the boundary-representative line segment groups from other line segment groups detected in the captured image, an example of which is shown in FIG. 2E, may be performed by determining proximities of endpoints of line segment groups and identifying line segment groups with the nearest endpoints as representing the boundaries of the document.

For example, to determine the four polylines that represent the four boundaries of a document, the line segment groups may be divided into four categories, where each category is associated with one boundary of the document. To achieve this, top and bottom document areas may be defined by a horizontal axis. Left and right document areas may be defined by a vertical axis. The horizontal and vertical axes may be selected to bisect the captured image based on the premise that the document is the central subject of the image. A line segment group that is located above the horizontal axis may be taken as a candidate for the document's upper boundary. A line segment group that is located below the horizontal axis may be taken as a candidate for the document's bottom boundary. A line segment group that is located to the left of the vertical axis may be taken as a candidate for the document's left boundary. A line segment group that is located to the right of the horizontal axis may be taken as a candidate for the document's right boundary. As such, each line segment group may be categorized as upper, lower, left, or right.

Then, one line segment group is selected from each category to represent each of the four boundaries of the document. The selected line segment groups are those that are longest and have the nearest endpoints.

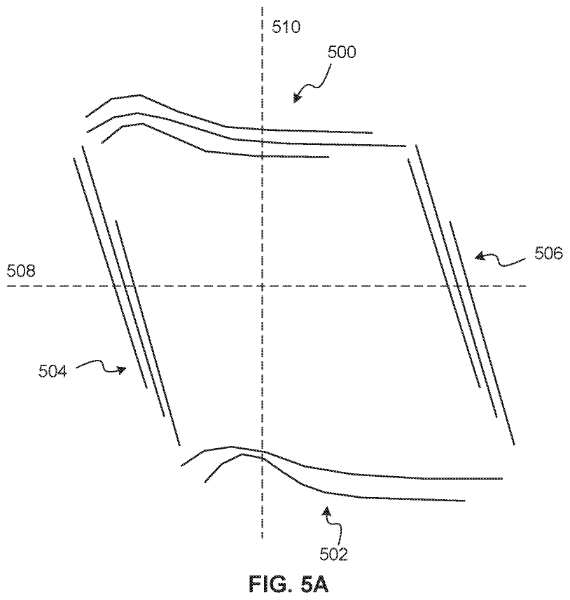

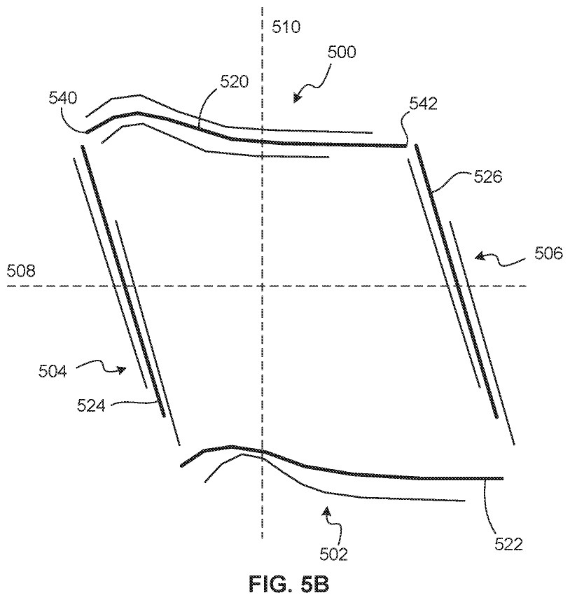

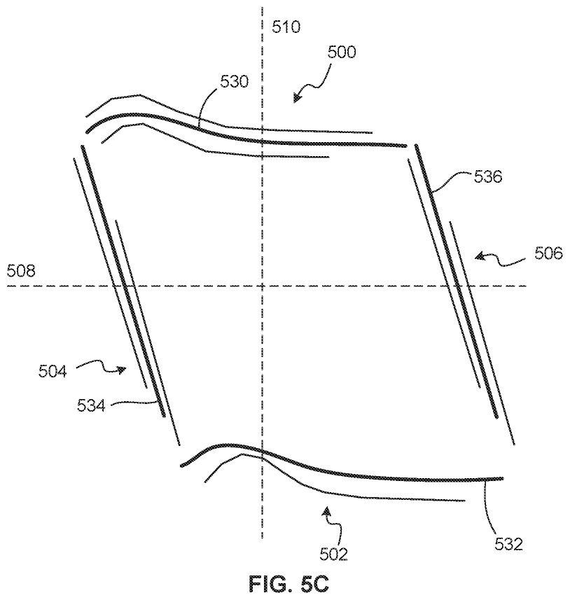

FIG. 5A shows example line segment groups categorized into upper 500, lower 502, left 504, and right 506 categories based on comparison with a horizontal axis 508 and a vertical axis 510. In various examples, if all endpoints of all segments in a line segment group lie on one side of an axis 508, 510, then that line segment group may be considered a member of the respective category 500, 502, 504, 506.

As shown in FIG. 5B, a line segment group in each category 500, 502, 504, 506 may be selected based on a comparison of line segment group lengths and endpoint proximity. For example, in each category (upper 500, lower 502, left 504, right 506), a length may be computed for each line segment group. The length of a line segment group may be the sum of the lengths of the constituent line segments.

Each line segment group has two endpoints (e.g., 540, 542) which are the opposite endpoints of the furthest separated constituent line segments. Endpoint proximity may be computed for pairs of line segment groups in adjacent categories (upper 500, lower 502, left 504, right 506). For example, line segment groups in the upper category may have endpoints distances computed with respect to line segment groups in the left category and line segment groups in the right category. Similarly, line segment groups in the lower category may have endpoints distances computed with respect to line segment groups in the left category and line segment groups in the right category. Line segment groups in the left category may have endpoints distances computed with respect to line segment groups in the upper category and line segment groups in the lower category. Similarly, line segment groups in the right category may have endpoints distances computed with respect to line segment groups in the lower category and line segment groups in the upper category.

Each line segment group may be assigned a score based on its endpoint proximity to line segment groups in neighboring categories and its length. The line segment group with the highest score in each category (upper 500, lower 502, left 504, right 506) may be selected as the representative of the respective page boundary. Weightings may be applied to arrive at a score, with the intent of identifying line segment groups that are longest and have the closest endpoints.

In some examples, all combinations of upper 500, lower 502, left 504, and right 506 line segment groups are enumerated and a total distance between endpoints of the line segment groups is computed for each combination. The combination with the smallest total distance is selected as the best representative of the page boundaries. Total distance may be considered a type of score, in which smaller total distances are considered to be higher scores.

In the example of FIG. 5B, a line segment group 520 is selected from the upper category 500, a line segment group 522 is selected from the lower category 502, a line segment group 524 is selected from the left category 504, and a line segment group 526 is selected from the right category 506. The line segment groups 520, 522, 524, 524 are those determined to have a suitable combination of length and endpoint proximity with other line segment groups in adjacent categories. Example selected line segment groups are shown in FIG. 2E with respect to an example captured image.

The discriminated boundaries of the document, as represented by selected line segment groups 520, 522, 524, 524, are then fitted to nonlinear curves. Each selected line segment group 520, 522, 524, 524 may be approximated by a polynomial equation. A least squares method may be used. With reference to FIGS. 5B and 5C, line segment groups 520, 522, 524, 526 are curve fitted to obtain respective polynomial curves 530, 532, 534, 536. Any suitable polynomial degree, such as second degree or third degree, may be used, recognizing that fitting to higher order polynomials generally requires greater processing resources.

The polynomial curves 530, 532, 534, 536 are nonlinear curves 110 (FIG. 1) that may be taken as representative of the document page boundaries. It should be noted that a polynomial curve may appear straight or be close to straight without being mathematically linear. It is contemplated that a possible loss of accuracy in modeling an apparent linear boundary as a nonlinear curve is acceptable given an increase in accuracy achievable by modeling, in the same image, an apparent nonlinear boundary as a nonlinear curve.

With reference back to FIG. 1, the nonlinear curves 110 may be used to transform a captured image 108 into a dewarped image 112. Each pixel of a dewarped image 112 may be mapped to a corresponding source pixel of the captured image 108 in an area defined by the nonlinear curves 110. Source pixel information (e.g., color, intensity, etc.) may then be used to construct the dewarped image 112.

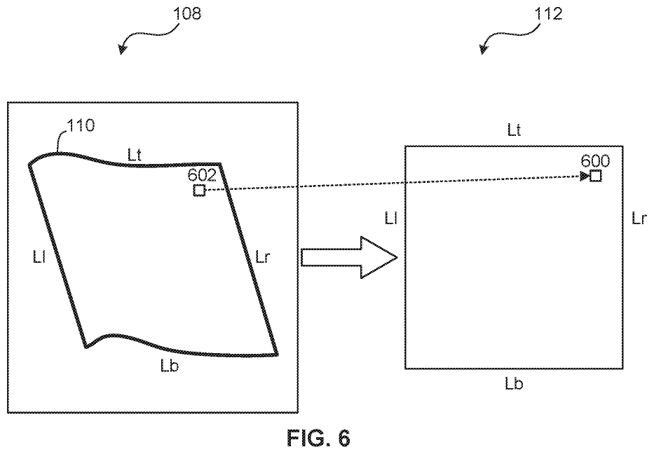

As shown in FIG. 6, the dimensions of the dewarped image 112 may be dictated by the lengths of the nonlinear curves 110. Curved document boundaries of lengths Lt, Lb, Ll, Lr in the captured image 108 may be transformed into straight and orthogonal lines of the same respective lengths Lt, Lb, Ll, Lr, which may be taken as the dimensions of the dewarped image 112.

For each pixel 600 of the dewarped image 112, the pixel's position within the rectangular boundaries of the dewarped image 112 may be used in an interpolation to identify a source pixel 602 within area of the captured image 108 bounded by the nonlinear curves 110. Linear interpolation may be used. For example, a dewarped pixel 600 may be determined to be a certain distance along the length Lt in the dewarped image 112. Such distance may be normalized to the length Lt, for example, represented as 0 to 1, where 0 is at one end of the length Lt and 1 is at the opposite end of the length Lt. Then the true position of the corresponding source pixel 602, along the length Lt of the curved boundary in the captured image 108, may be computed using the same normalized distance. The same applies to lengths Lb, Ll, and Lr. The influence of a pixel's normalized distance along a length Lt, Lb, Ll, Lr may be weighted based on the distance of that pixel from that length Lt, Lb, Ll, Lr. For example, pixels 600 near the upper length Lt in the dewarped image 112 may have identification of their source pixels 602 in the captured image 108 influenced more by the upper boundary curve that the the lower boundary curve.

As such, source pixel information may be geometrically transformed into dewarped pixel information, as shown in FIG. 2G. The resulting dewarped image 112 may be enhanced by, for example, contrast, brightness, or sharpness adjustment to obtain an enhanced dewarped image 112, as shown in FIG. 2H.

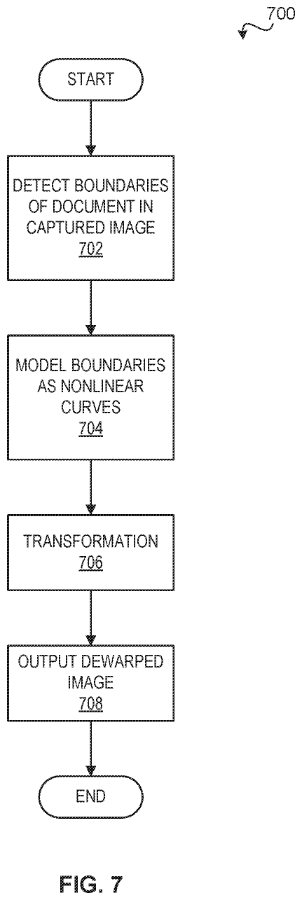

FIG. 7 shows an example process 700 for using nonlinear curves to represent document boundaries in a captured image and outputting a dewarped image of the document based on the nonlinear curves.

At block 702, boundaries of a representation of a document page are detected in a captured image. This may include identifying line segments, such as by using edge detection and line segment detection, and then connecting or associating line segments that have nearby endpoints and similar angles. Candidate document page boundaries may be initially represented as groups of line segments that are apparently connected.

At block 704, the boundaries of the representation of the document page are modelled as nonlinear curves. For example, the polyline candidate document page boundaries may be compared for endpoint proximity and length, with polylines that are longer and that have closer endpoints being favored. Then, with reference to the principle that the captured image contains the document page as the main subject in an orientation that puts its boundaries generally aligned with the image boundaries, a suitable group of line segments is selected to map to each of the four document page boundaries. Then, each group of selected line segments is fitted to a nonlinear curve, such as a polynomial curve. One polynomial curve may be obtained for each of the four linear outside boundaries of a rectangular document page.

At block 706, the four nonlinear curves are used to transform pixels of the captured image into pixels of a dewarped image. Interpolation may be used to map each pixel in the dewarped image to a source pixel in the captured image. The dewarped image may thus contain a dewarped representation of the document page that was the main subject of the captured image.

Then, at block 708, the dewarped image is outputted. For example, the dewarped image may be saved to a non-transitory computer-readable medium, may be transmitted over a computer network, may be displayed to a user via a display device, or similar.

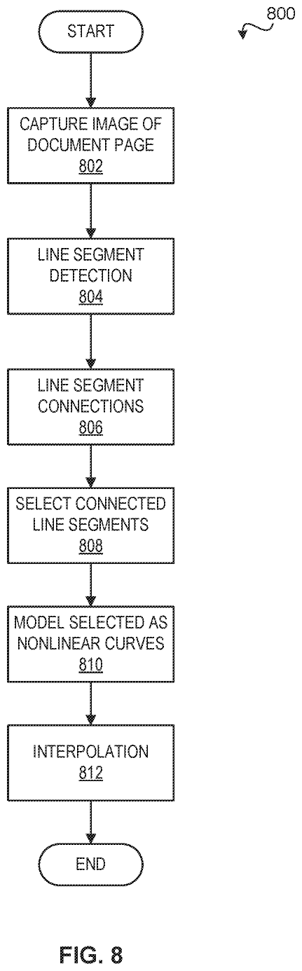

FIG. 8 shows an example process 800 of using nonlinear curves to represent document boundaries and using such nonlinear curves to perform an interpolation on captured image of the document.

At block 802, an image of a generally rectangular document page is captured. For example, a user may place a document on a surface and use a handheld computing device to capture an image of the document.

At block 804, line segment detection is performed on the captured image. Line segment detection may include edge detection.

At block 806, line segments are connected based on endpoint proximity and relative angle. The techniques discussed with reference to FIG. 4 may be applied. Pairs of line segments may be considered. For example, a first segment that has an endpoint sufficiently close to an endpoint of a second segment may be determined to be connected to the second segment, provided that an angle between the first and second segments is sufficiently close. As such, detected line segments that are too far apart may be considered unconnected. Further, detected line segments that have too much angular disparity may be considered unconnected, as the boundaries of documents being photographed are contemplated to have relatively gentle curvature. Each line segment may thus be determined to belong to one set of connected line segments (e.g., a polyline).

At block 808, each set of connected line segments may be considered a candidate of best representative of a particular document boundary (e.g., upper, lower, left, right). Each set of connected line segments has two endpoints that are the opposite endpoints of the first and last constituent line segments. Sets of connected line segments may be tested for endpoint proximity and length to identify four sets of connected line segments that best represent the four boundaries of the document page.

At block 810, the selected connected line segments are each modelled as a nonlinear curve. Polynomial curve fitting may be used. The nonlinear curves describe the boundaries of the document page, as apparent in the captured image. It should be noted that the process 800 does not refer to the content of the captured image to obtain the nonlinear curves.

Then, at block 812, the nonlinear curves are used in an interpolation or transformation to convert pixels in the captured image to pixels in a dewarped image, which may then be outputted. The dewarped image thus compensates for warping or other curvature in the document content, which may be caused by the conditions of taking the captured image, optical effects of the camera taking the captured image, and similar defects.

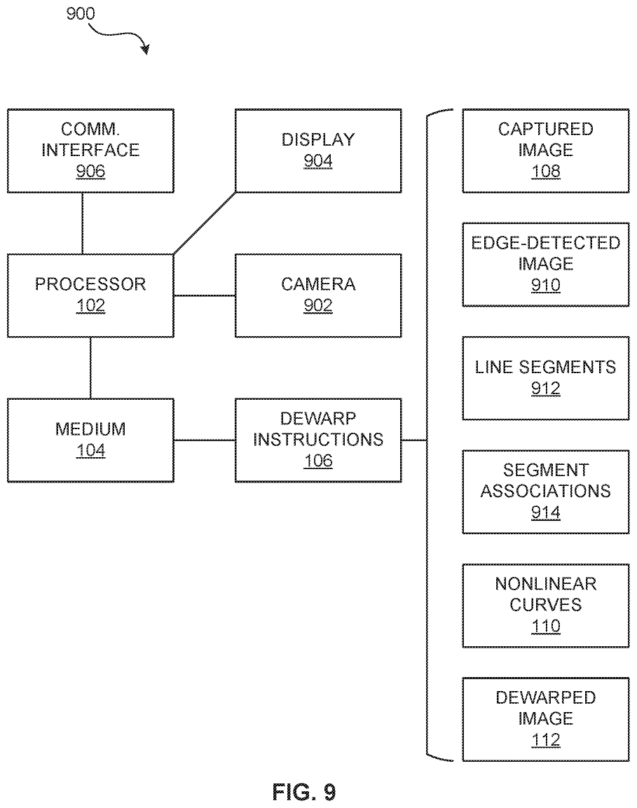

FIG. 9 shows an example device 900 that uses nonlinear curves to output a dewarped version of a captured image. The device 900 includes a processor 102 and a non-transitory computer-readable medium 104. Features and aspects of the device 100 discuss above may be referenced for those not described in detail here. The device 900 may be a handheld computing device, such as a smartphone, tablet computer, smart watch, or the like.

The device 900 may further include a camera 902 connected to the processor 102. The camera 902 may be used to capture images in the vicinity of the device 900, such as images of documents.

The device 900 may further include a display 904, such as a touchscreen display. The display 904 may be used to display information to the user of the device 900, such as captured images of documents and dewarped version of such captured images.

The device 900 may further include a communications interface 906 to communicate data with a computer network. The communications interface 906 may include a wireless interface, such as an Institute of Electrical and Electronics Engineers (IEEE) 802.11 interface, a mobile/cellular network interface, or similar. The device 900 may thus share information, such as images, with other devices and with computer servers.

The device 900 may include dewarp instructions 106 to model boundaries of a document page in a captured image 108 as nonlinear curves 110. The dewarp instruction may further use the nonlinear curves 110 to generate a dewarped image 112 of the document page. Dewarped images 112 may be stored at the non-transitory computer-readable medium 104, displayed at the display 904, or communicated via the communications interface 906.

During the processing of a captured image 108 to obtain a dewarped image 112, the medium 104 may be used to store relevant information, such as an edge-detected image 910 (e.g., FIG. 2B), an image of line segments 912 (e.g., FIG. 2C), and line segment associations 914. The instructions 106 may generate this information and may operate on this information. Other information may also be stored. The edge-detected image 910, image of line segments 912, line segment associations 914, and nonlinear curves 110 may be deleted after the respective dewarped image 112 is obtained. The respective captured image 108 may also be deleted.

In view of the above, it should be apparent that an image of a document may be dewarped without analysis or knowledge of document content, such as text. An efficient tradeoff between speed and accuracy may be obtained, particularly by recognizing that captured images of documents tend to have certain characteristics, as discussed above. Image dewarping of documents may be fast enough to meet expectations of handheld device users and accurate enough to sufficiently approximate a flatbed scanner or other specialized equipment.

It should be recognized that features and aspects of the various examples provided above can be combined into further examples that also fall within the scope of the present disclosure. In addition, the figures are not to scale and may have size and shape exaggerated for illustrative purposes.

1. A non-transitory computer-readable medium comprising instructions executable by a processor to:
detect boundaries of a representation of a document page in a captured image;
model the boundaries of the representation of the document page as nonlinear curves;
use the nonlinear curves to transform pixels of the representation of the document page into pixels of a dewarped representation of the document page; and
output a dewarped image based on the dewarped representation of the document page.

2. The non-transitory computer-readable medium of claim 1, wherein the instructions are further to obtain the nonlinear curves without reference to document content.

3. The non-transitory computer-readable medium of claim 1, wherein the instructions are further to discriminate the boundaries from line segments detected in the captured image by determining proximities of endpoints of the line segments and identifying line segments with nearest endpoints as belonging to the boundaries.

4. The non-transitory computer-readable medium of claim 3, wherein the instructions are further to detect line segments in the captured image and associate related line segments.

5. The non-transitory computer-readable medium of claim 4, wherein the instructions are further to associate line segments with reference to end-point proximity and angle between pairs of line segments.

6. The non-transitory computer-readable medium of claim 1, wherein the instructions are further to perform interpolation with the nonlinear curves to transform the pixels of the representation of the document page into the pixels of the dewarped representation of the document page.

7. The non-transitory computer-readable medium of claim 1, wherein the nonlinear curves include a polynomial curve for each of four linear outside boundaries of a rectangular document page.

8. A computing device comprising:
a camera to obtain a captured image of a document; and
a processor connected to the camera, the processor to:
detect boundaries of the document in the captured image;
model the boundaries of the document as polynomial curves;
transform the captured image into a dewarped image using the polynomial curves; and
output the dewarped image.

9. The computing device of claim 8, wherein the processor is further to detect line segments in the captured image.

10. The computing device of claim 9, wherein the processor is further to connect line segments into sets of line segments, wherein the sets of line segments represent candidates for the boundaries of the document.

11. The computing device of claim 10, wherein the processor is further to connect line segments that have proximate endpoints.

12. The computing device of claim 10, wherein the processor is further to connect line segments that have a mutual angle within a predefined range.

13. The computing device of claim 10, wherein the processor is further to select sets of line segments that have proximate endpoints as representative of the boundaries of the document.

14. The computing device of claim 13, wherein the processor is further to use selected sets of line segments to model the polynomial curves.

15. A method comprising:
detecting candidate boundaries of a document page in a captured image;
modelling selected candidate boundaries of the document page as nonlinear curves;
using the nonlinear curves to perform an interpolation to obtain pixels of a dewarped image of the document page from pixels of the captured image; and
outputting a dewarped image of the document page.
